(19) United States
(12) Patent Application Publication
(10) Pub. No.: US 2007/0121481 A1
(43) Pub. Date: May 31, 2007

(54) Optical disk drive apparatus and optical recording-reproducing apparatus

(76) Inventor: Nobuhiko Tsukahara, Kanagawa (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 11/599,007

(22) Filed: Nov. 13, 2006

(30) Foreign Application Priority Data
Nov. 30, 2005 (JP) JP 2005-346457

(51) Int. Cl. G11B 3/70

(52) U.S. Cl. 369/291.1

(57) ABSTRACT

An optical disk drive apparatus includes a cylindrical space forming unit that forms a cylindrical space. In the cylindrical space, an optical disk is located such that an upper surface, a lower surface and an edge of an outer circumference of an optical disk face inner surfaces of the cylindrical space forming unit with a predetermined distance.

### CROSS REFERENCES TO RELATED APPLICATIONS

The present invention contains subject matter related to Japanese Patent Application JP 2005-346457 filed in the Japanese Patent Office on Nov. 30, 2005, the entire contents of which being incorporated herein by reference.

### BACKGROUND OF THE INVENTION

1. Field of the Invention

The present invention relates to an optical disk drive apparatus and an optical disk recording-reproducing apparatus for rotating an optical disk to record data on and/or reproduce data from the optical disk.

2. Description of the Related Art

In the recent years, attempts have been made on an optical disk drive apparatus to increase recording and reproducing speeds by rotating an optical disk at a rotational speed of approximately 10000 rpm (revolutions per minute). Since air generally has a viscous nature, the air present close to the upper and lower surfaces of the optical disk flows in the radius direction of the optical disk as well as flowing in the circumferential direction of the optical disk. Of the inside of the optical disk drive apparatus, mechanical parts are asymmetrically arranged around the optical disk, and hence the air flows asymmetrically relative to the upper and lower surfaces of the optical disk due to the influences caused by arrangements of the mechanical parts. The airflow flowing from the outer circumference of the optical disk causes an additional airflow to flow in various directions. In other words, pressures are ununiformly distributed around the optical disk and hence the distributions of pressures are constantly fluctuated.

Under such conditions, since fluctuation in the airflow pressure distribution and the optical disk vibration interfere with each other, the optical disk significantly vibrates with deformation. Further, under certain conditions, the optical disk may be damaged due to excess deformation of the optical disk.

A related art has proposed a technology for preventing vibration of an optical disk in which a straightening plate is provided close to the circumference of the optical disk for straightening airflow around the surfaces of the optical disk to control disk vibration.

Japanese-Unexamined Patent Publication No. 2000-357385 and Japanese Patent No. 3630600, for example, disclose a structure in which a concentric-circle shaped partition wall, an annular protrusion, or an annular groove is provided in the vicinity of the disk surface of the optical disk for limiting airflow in the radius direction to prevent disk vibration.

In the recent application of a CD-ROM (Compact Disk-Read Only Memory) to a computer, Japanese Unexamined Patent Publication No. 2003-68051 discloses a technology in which a disk-like enclosure is provided around an optical disk for enclosing the surfaces of the optical disk to control the airflow and hence prevent disk vibration.

### SUMMARY OF THE INVENTION

Recently, optical disk drive apparatus are expected to demonstrate even higher recording and reproducing speed, and a rotational speed of an optical disk is about to exceed 10000 rpm or about to reach 20000 rpm. However, with the aforementioned methods (Japanese Unexamined Patent Publication No. 2000-357385 and Japanese Patent No. 3630600) where the concentric circle shaped partition wall, the annular protrusion, or the annular groove is provided close to disk surfaces, it appears difficult to limit airflow in the radius direction of the disk for preventing disk vibration when the rotational speed is reaching as high speed as 20000 rpm.

According to the data presented in the Japanese Patent No. 3630600 (FIG. 3 of the patent document), for example, the experimental results obtained from the optical disk drive apparatus with the annular protrusion have shown an increase in disk vibration amplitude if rotational speed of the disk exceeds 10000 rpm. This implies that an increase in disk resonance amplitude will further increase if the optical disk rotates at 20000 rpm.

According to Japanese Unexamined Patent Publication No. 2003-68051, the disclosed technology can only control disk vibration of a CD-ROM player having recording speed at up to 12× speed; that is, at a rotational speed of approximately 2400 rpm in the outer circumference of the optical disk and at a rotational speed of approximately 6000 rpm in the inner circumference of the optical disk. However, the technology has not examined an effect on controlling disk vibration of the CD-ROM at a rotational speed of 10000 rpm or more (i.e., higher than 6000 rpm), specifically, at a rotational speed of approximately 20000 rpm.

According to an embodiment of the present invention, there is provided an optical disk drive apparatus and an optical recording-reproducing apparatus which are capable of controlling disk resonance caused by interference between airflow and vibration of the optical disk, and allow the optical disk to rotate at high speed with stability.

According to an embodiment of the present invention, an optical disk drive apparatus including a cylindrical space forming unit that forms a cylindrical space, in which an optical disk is located such that an upper surface, a lower surface and an edge of an outer circumference of an optical disk face respective inner surfaces of the cylindrical space forming unit with a predetermined distance.

According to an embodiment of the present invention, the optical disk drive apparatus may preferably be configured such that a distance between the edge of the outer circumference of the optical disk and the inner surface of the cylindrical space forming unit falls within a range of 1 mm to 10 mm.

Further, according to an embodiment of the present invention, the optical disk drive apparatus may preferably be configured such that a distance between the upper and lower surfaces of the optical disk and the respective inner surfaces of the cylindrical space forming unit facing the upper and lower surfaces of the optical disk falls within a range of 1 mm to 4 mm.

According to an embodiment of the present invention, an optical recording-reproducing apparatus for recording and/or reproducing data by irradiating an optical disk with light includes an optical disk drive apparatus having a cylindrical space forming unit forming a cylindrical space where the optical disk is located such that an upper surface, a lower surface and an edge of an outer circumference of an optical disk face respective inner surfaces of the cylindrical space forming unit with a predetermined distance.

As described above, in the optical disk drive apparatus and the optical recording-reproducing apparatus according to an embodiment of the present invention, an optical disk is located at the cylindrical space of the cylindrical space forming unit which encloses the upper surface, the lower surface and the edge of the outer circumference of the optical disk. Enclosing the outer circumference in addition to enclosing the upper and lower surfaces of the optical disk can, in particular, virtually enclose the optical disk in the optical disk drive apparatus with an airtight condition, inside of which the optical disk is loaded and rotated.

According to the above-mentioned arrangement, when rotating the optical disk at a high speed, the occurrence of the airflow in the radius direction close to the upper and lower surfaces of the optical disk can be prevented, and fluctuations of a pressure distribution of airflow can be minimized, thereby decreasing disk resonance amplitude.

Specifically, as will be described later in detail in embodiments, if the distance between the edge of the outer circumference of the optical disk and the inner surface of the cylindrical space forming unit is within the range of 1 mm to 10 mm, and the distance between the upper and lower surfaces of the optical disk and the respective inner surfaces facing the upper and lower surfaces of the cylindrical space forming unit is within a range of 1 mm to 4 mm, the resonance amplitude of the optical disk can reliably be controlled with the optical disk being rotated at a high speed of 20000 rpm.

As set forth above, according to an embodiment of the present invention, the optical disk drive apparatus and the optical recording-reproducing apparatus are capable of controlling optical disk resonance and allow the optical disk to rotate at high speed with stability when performing high-speed rotation of the optical disk.

### BRIEF DESCRIPTION OF THE DRAWINGS

FIG. 1 is a schematic cross-sectional view showing arrangements of main portions of an optical disk drive apparatus according to an embodiment of the present invention;

FIG. 2 is a diagram showing a characteristic curve obtained when resonance amplitude of the optical disk drive apparatus according to the embodiment of the present invention was measured;

FIG. 3 is a schematic cross-sectional view showing arrangements of main portions of an optical disk drive apparatus according to a comparative example of the related art;

FIG. 4 is a diagram showing characteristic curves obtained when resonance amplitude of the examples of the optical disk drive apparatus according to comparative examples was measured;

FIG. 5A is a diagram showing a disk vibration amplitude obtained when disk resonance was not generated;

FIG. 5B is a diagram showing a disk vibration amplitude obtained when disk resonance was generated;

FIG. 6 is a diagram showing a pressure distribution and a centrifugal force distribution inside the enclosure;

FIG. 7 is a diagram showing an airflow rate distribution around the surface of the optical disk;

FIG. 8 is a schematic cross-sectional view showing arrangements of main portions of an optical disk drive apparatus according to an embodiment of the present invention;

FIG. 9 is a schematic cross-sectional view showing arrangements of main portions of an optical disk drive apparatus according to an embodiment of the present invention;

FIG. 10 is a schematic cross-sectional view showing arrangements of main portions of an optical disk drive apparatus according to another embodiment of the present invention;

FIG. 11 is a schematic plan view showing arrangements of main portions of an optical disk drive apparatus according to a further embodiment of the present invention;

FIG. 12 is a diagram showing characteristic curves obtained when resonance amplitude of the respective embodiments of the optical disk drive apparatus shown in FIGS. 9, 10 and 11 was measured;

FIG. 13 is a diagram showing characteristic curves obtained when resonance amplitude was measured while the distance between the surfaces of the optical disk and the inner surfaces of the enclosure was changed;

FIG. 14 is a diagram showing characteristic curves obtained when resonance amplitudes were measured while the distance between the edge of the outer circumference of the optical disk and the inner surface of the enclosure facing the edge is changed;

FIG. 15 is a schematic cross-sectional view showing the state in which an optical disk is loaded on an optical recording-reproducing apparatus according to an embodiment of the present invention;

FIG. 16 is a schematic cross-sectional view showing the state in which an optical disk is ejected from the optical recording-reproducing apparatus according to the embodiment of the present invention; and

FIG. 17 is a schematic cross-sectional view showing the state in which an optical disk is ejected from an optical recording-reproducing apparatus according to another embodiment of the present invention.

### DESCRIPTION OF THE PREFERRED EMBODIMENTS

Embodiments of the present invention will now be described below with reference to the drawings and it is needless to say that the present invention may not be limited to the embodiments which will follow.

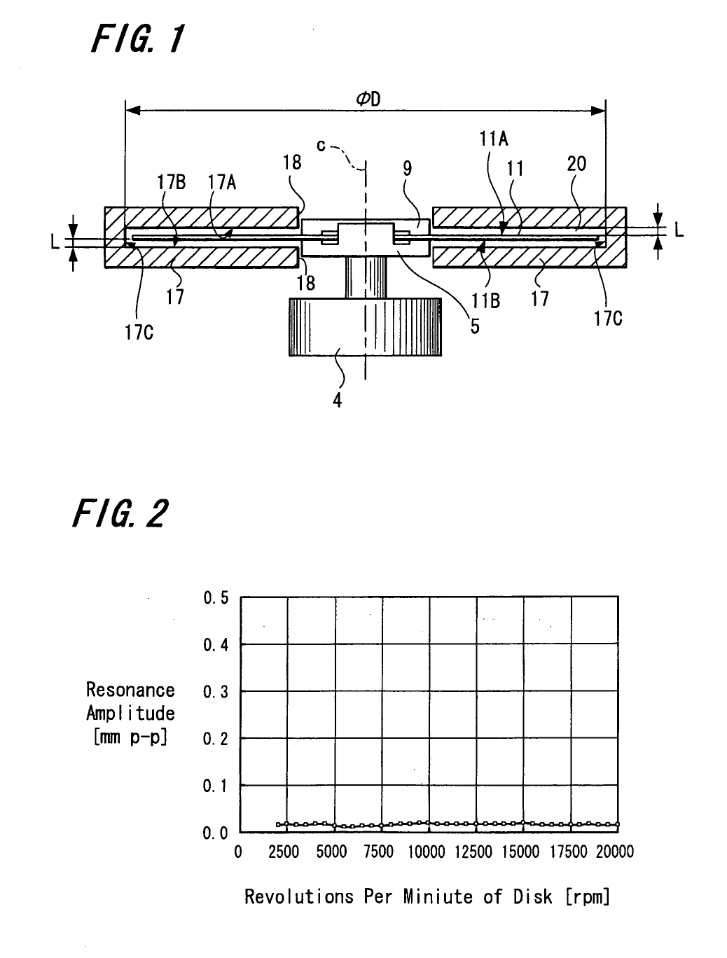

FIG. 1 is a schematic cross-sectional view showing arrangements of main portions of an optical disk drive apparatus according to an embodiment of the present invention.

As shown in FIG. 1, an optical disk 11 is loaded on a turntable 5 mounted on a spindle motor 4 and clamped on the turntable 5 with a disk clamper 9. The circumference of the optical disk 11 is enclosed with an enclosure 17 and the optical disk 11 is located at a cylindrical space 20 formed by the enclosure 17. More specifically, the enclosure 17 is used as a space forming unit that forms the cylindrical space 20. The enclosure 17 includes a turntable insertion slot 18 located at the center of the enclosure. It is preferable that a distance L between an upper and lower surfaces 11A and 11B of the optical disk 11 and inner surfaces 17A and 17B facing the upper and lower surfaces 11A and 11B of the optical disk 11 be appropriately determined in accordance with a rotational speed of the optical disk 11. It is also preferable that a diameter D of an inner circumferential surface 17C of the enclosure 17 be appropriately determined in accordance with a rotational speed of the optical disk 11. A single dot-dash line c in FIG. 1 shows a rotation central axis of the spindle motor 4.

FIG. 2 is a graph plotting a characteristic curve obtained by measuring disk resonance amplitude under a condition where a rotational speed of the optical disk 11 was changed from 2000 rpm to 20000 rpm. A definition of the disk resonance amplitude will be described later. The disk resonance amplitude was measured under a condition where the distance L between the upper and lower surfaces 11A and 11B of the optical disk 11 and the inner surfaces 17A and 17B of the enclosure 17 was determined as 2 mm, and the diameter D of the inner circumferential surface of the enclosure 17 was determined as 125 mm. FIG. 2 shows that the disk resonance amplitude did not increase at a rotational speed exceeding 10000 rpm, implying that there would be a significant effect on preventing disk resonance at all rotational speeds ranging from 2000 rpm to 20000 rpm.

Referring to the measurement example of FIG. 2, the maximum rotational speed is limited to 20000 rpm due to the restrictions of the optical disk drive apparatus; however, based on a principle of preventing occurrence of airflow in the radius direction by creating an equilibrium state between pressure and centrifugal force, an effect on preventing disk resonance may well be obtained in a case where the rotational speed reaches 20000 rpm or more.

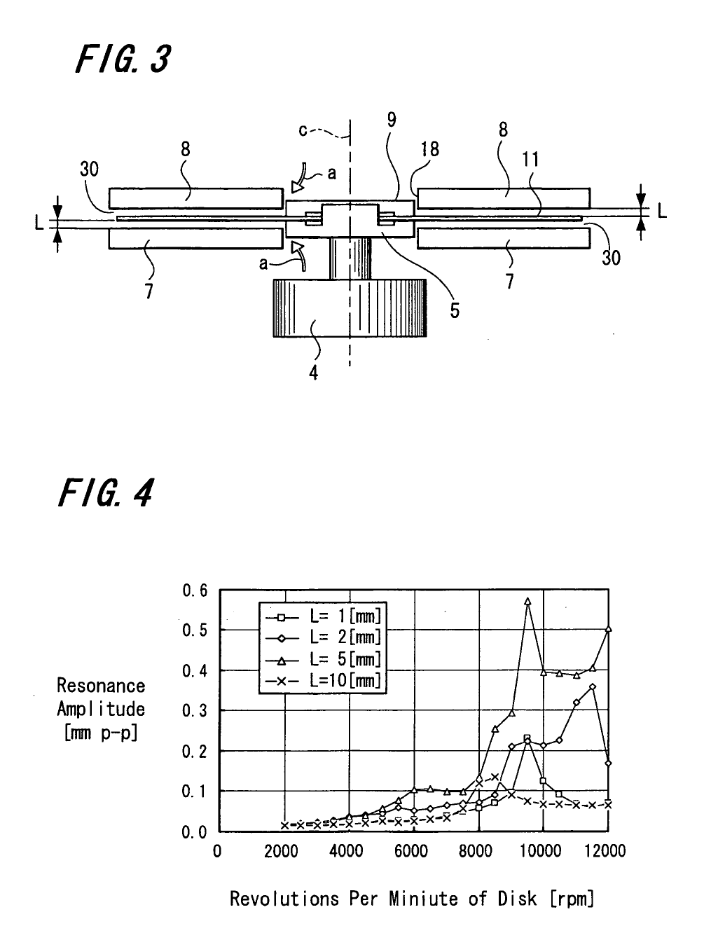

In contrast, disk resonance amplitude was measured in the related-art type optical disk drive apparatus where the edge of the outer circumference of the optical disk 11 is not enclosed with the enclosure. FIG. 3 is a schematic cross-sectional view showing arrangements of main portions of the related-art type optical disk drive apparatus. As shown in FIG. 3, covers 7 and 8 are separately located to cover the upper surface 11A and the lower surface 11B of the optical disk 11, and there is a space 30 between the covers 7 and 8 relative to the circumference of the optical disk. In FIG. 3, elements and parts identical to those of FIG. 1 are denoted by identical reference numerals and corresponding descriptions are thus omitted.

According to the related-art optical disk drive apparatus of the comparative example, disk resonance amplitude was measured under conditions where the distance L between the surfaces of the optical disk 11 and the respective inner surfaces of the lower and upper covers 7 and 8 was determined as 1 mm, 2 mm, 5 mm, or 10 mm (four measurements), with the rotational speed of the optical disk 11 being changed within a range of 2000 rpm to 12000 rpm. FIG. 4 shows measurement results of the disk resonance amplitude in the comparative example.

FIG. 4 shows that if the rotational speed exceeds 9000 rpm under conditions where the distance L between the surfaces of the optical disk 11 and the respective inner surfaces of lower and upper covers 7 and 8 is determined as 1 or 2 mm, an increase in the optical disk resonance amplitudes is obtained, implying that there would be no effect on preventing disk vibration.

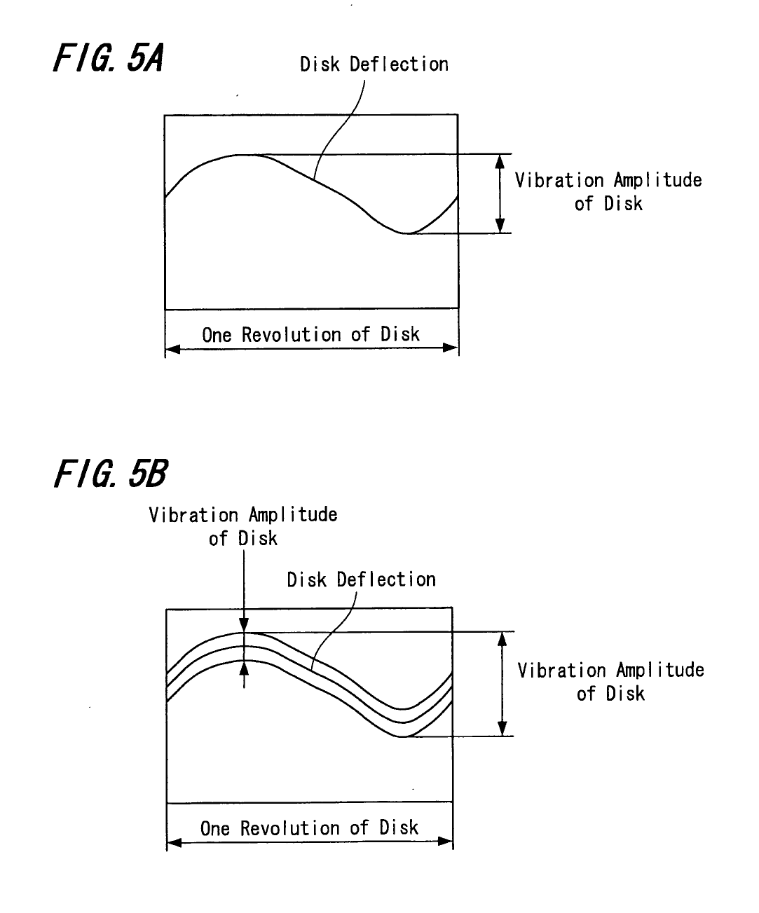

Subsequently, the definition of the optical disk resonance amplitude shown in FIGS. 2 and 4 will be described with reference to FIGS. 5A and 5B. In a case where no disk resonance is generated, a number of repeatedly measured results of disk deflection plot a single curved line shown in FIG. 5A. If disk resonance is generated, a number of repeatedly measured results of the disk deflection plot curved lines with a certain amplitude as shown in FIG. 5B. This amplitude is defined as “disk resonance amplitude”.

FIGS. 5A and 5B show that when there is no disk resonance, [disk vibration amplitude]=[disk deflection] is determined; and when there is disk resonance, [disk vibration amplitude] =[disk deflection] +[disk resonance amplitude] is determined.

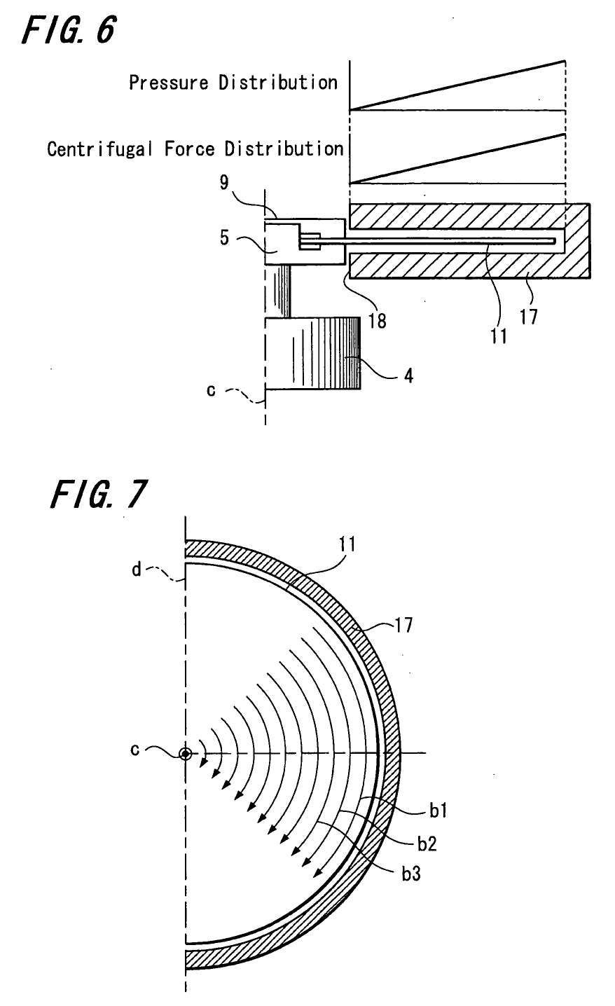

Effects introduced by the optical disk drive apparatus according to an embodiment of the present invention will be described with reference to FIGS. 6 and 7. FIG. 6 is a schematic cross-sectional view showing arrangements of main portion of the optical disk drive apparatus described with reference to FIG. 1, to which graphs showing pressure distributions obtained inside the enclosure when the optical disk is stably rotated and centrifugal force distributions of airflow obtained when the optical disk is stably rotated are applied in relation to the position corresponding to the radius direction of the optical disk. In FIG. 6, elements and parts identical to those of FIG. 1 are denoted by identical reference numerals and corresponding descriptions are thus omitted. As shown in FIG. 6, linear increases in the pressure distribution and the centrifugal distribution are observed from the center to the outer circumference of the optical disk.

When the optical disk 11 begins to rotate from the stop mode, airflow flows in the radius direction as well as flowing in the circumferential direction of the optical disk 11. When the airflow flowing in the radius direction of the optical disk 11 is interrupted with the enclosure, the pressure of airflow is slightly increased around this part of the optical disk. If the increased pressure is still lower than the centrifugal force of the airflow, the airflow flowing in the radius direction cannot be interrupted, thereby increasing the pressure around the circumferential area of the optical disk. When the pressure is increased to the extent where the pressure around the circumferential area and the centrifugal force of the airflow are in equilibrium, no airflow is generated in the radius direction and an equilibrium state where the airflow only flows in the circumferential direction is observed.

FIG. 7 shows the equilibrium state. FIG. 7 is a plan view showing half portion of the optical disk 11 divided by plotting a single dot-dash line d across the middle of the optical disk 11. Refer to FIG. 7, in the optical disk drive apparatus according to an embodiment of the present invention, the outer circumference of the optical disk 11 is enclosed with the enclosure 17. When the pressure around the circumferential area of the optical disk 11 and the centrifugal force of the airflow are in equilibrium, no airflow is generated in the radius direction and an equilibrium state where only airflow distributions represented by concentric circles are obtained at a rotation axis c of the optical disk 11 as shown by arrows b1, b2, b3, . . . Hence, the velocity shows distributions proportional to the radius of the optical disk 11. Accordingly, owing to maintaining the stable airflow distributions, when the rotational speed increases up to approximately 20000 rpm, the increase of the resonance amplitude can be controlled.

Referring back to FIG. 3, in the case of the optical disk drive apparatus having the related-art arrangement according to the comparative example, since there is a space 30 between the covers 7 and 8 relative to the circumference of the optical disk, the airflow flowing in the radius direction may not be blocked off, resulting in causing the air to constantly flow from a turntable insertion slot 18 located at the center of the optical disk drive apparatus as shown by an outline arrow a. As a result, the stable airflow distributions represented by the concentric circles in FIG. 7 may not be obtained and hence the airflow distributions become ununifom, resulting in an increase in the resonance amplitude.

In contrast, according to an embodiment of the present invention, the airflow flowing in the radius direction close to the upper and lower surfaces of the optical disk can be prevented when the optical disk is rotated at a high speed. Thus, fluctuations of the pressure distributions of the airflow can be minimised and hence the increase of the disk resonance amplitude can be controlled or prevented.

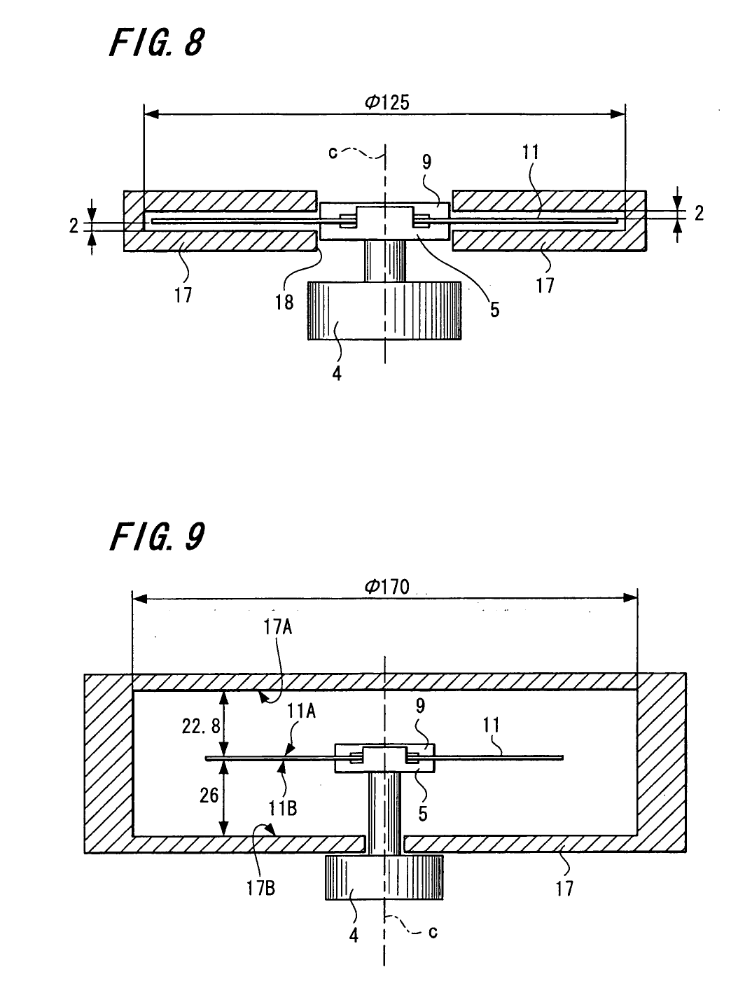

Next, differences of resonance amplitude relative to the rotational speed of the optical disk were examined with three types of arrangements of optical disk drive apparatus shown in FIGS. 8, 9, 10 and 11. In FIGS. 8 to 11, elements and parts identical to those of FIG. 1 are denoted by identical reference numerals and corresponding descriptions are thus omitted.

In FIG. 8, the optical disk drive apparatus includes a structurally similar enclosure 17 with the enclosure of the optical disk drive apparatus shown in FIG. 1. An inner diameter D of the inner circumferential surface 17C of the enclosure 17 was determined as 125 mm, and the distance L between the upper and lower surfaces 11A and 11B of the optical disk 11 and the respective inner surfaces 17A and 17B of the enclosure 17 were determined as 2 mm. This enclosure is referred to as an “enclosure A”.

In FIG. 9, the inner diameter of the inner circumferential surface 17C of the enclosure 17 was determined 170 mm. A distance between the upper surface 11A of the optical disk 11 and the inner surface 17A of the enclosure 17 was determined as 22.8 mm, and a distance between the lower surface 11B of the optical disk 11 and the inner surface 17B of the lower side of the enclosure 17 was determined as 26 mm. This enclosure is referred to as an “enclosure B”.

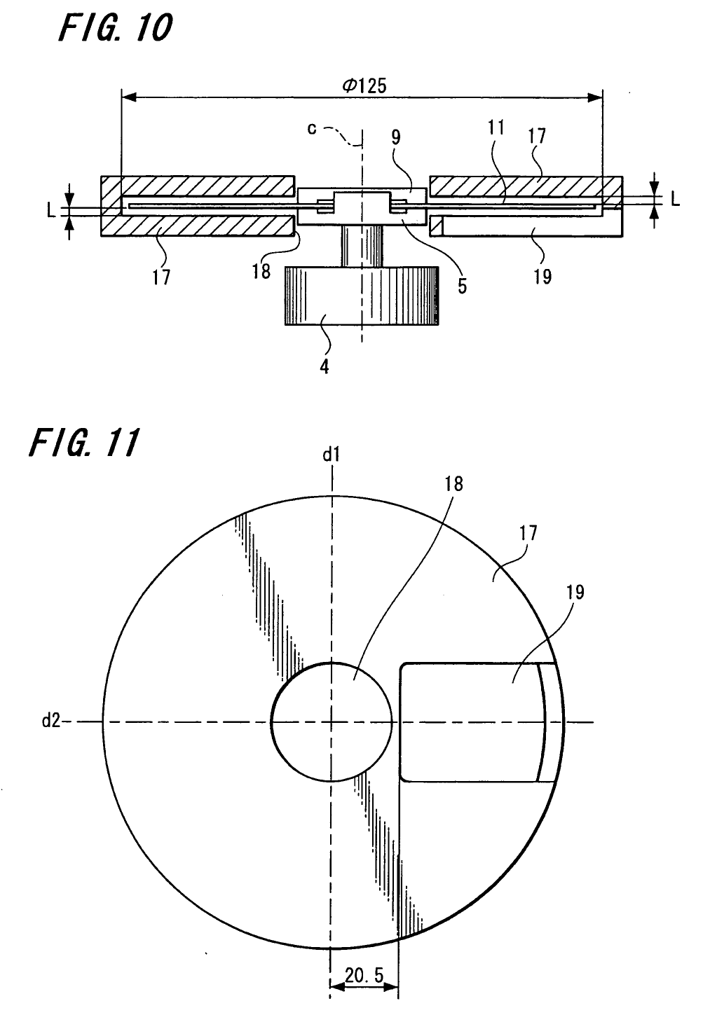

As shown in FIG. 10, the inner diameter of the inner circumferential surface of the enclosure 17 was determined as 125 mm, and the distance L between the upper and lower surfaces 11A and 11B of the optical disk 11 and the inner surfaces 17A and 17B of the enclosure 17 was determined as 2 mm. As shown in FIGS. 10 and 11, an optical pickup insertion opening portion 19 is formed at a portion of the enclosure 17. This enclosure will be referred to as an “enclosure C”. In FIG. 11, single dot-and-dash lines d1 and d2 show an intersection of the two single dot-and-dash lines that run at right angles to each other across the middle of the flat-circular represented enclosure 17. The optical pickup insertion opening portion 19 is formed at a position 20.5 mm from the center, that is, the intersection of the single dot-and-dash lines d1 and d2, to the outer circumferential side of the enclosure 17.

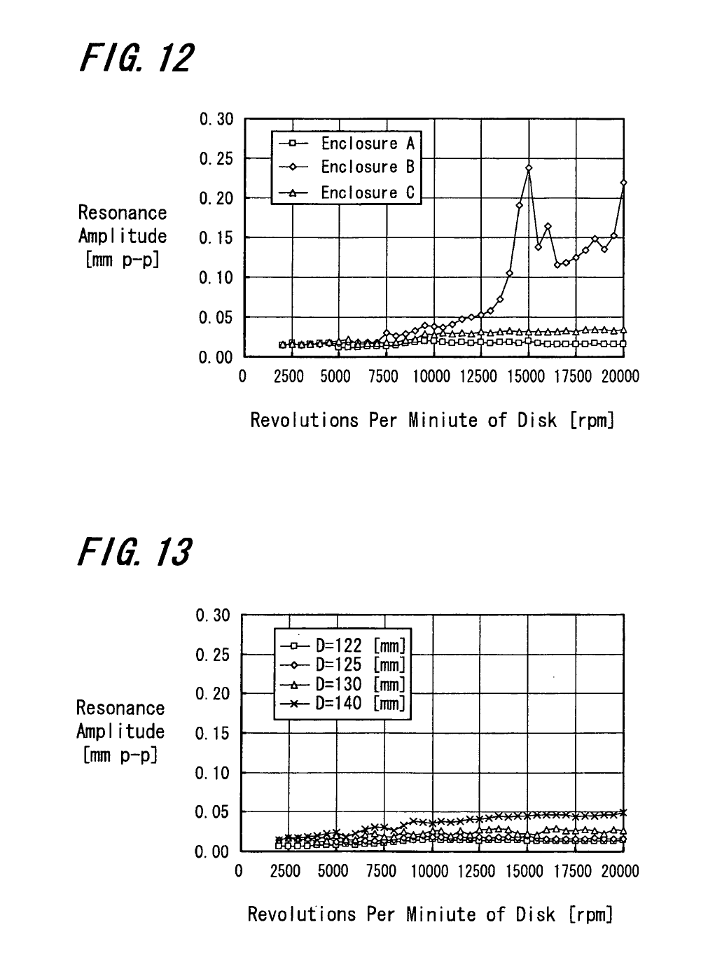

Resonance amplitude was measured with the enclosures A, B and C, respectively, while the rotational speed was changed within a range of 2000 rpm to 20000 rpm for each enclosure. FIG. 12 shows measurement results.

FIG. 12 shows that the resonance amplitude increased with the enclosure B when the rotational speed of the optical disk exceeded 12500 rpm.

The result shows that the distance between the upper and lower surfaces 11A and 11B of the optical disk 11 and the respective inner surfaces 17A and 17B of the enclosure 17, and the distance between the edge of the circumference of the optical disk 11 and the inner circumferential surface 17C of the enclosure 17 were both long enough to prevent an airflow flowing in the radius direction around the surfaces of the optical disk 11 under the condition where the outer circumference area of the optical disk 11 was air-tightly enclosed. Under the condition where the outer circumference area of the optical disk 11 was not enclosed, the resonance amplitudes are increased in a condition where the rotational speed exceeding 12500 rpm.

The results showed, however, when the optical pickup insertion slot 19 was formed at a portion of the lower surface of the enclosure 17, the resonance amplitude was not substantially changed. Thus, under such conditions where the optical disk 11 was rotated at a speed as high as 20000 rpm, the resonance amplitude can be sufficiently controlled by appropriately determining a distance between the inner surfaces 17A and 17B of the enclosure 17 and the surfaces of the optical disk 11, or by appropriately determining a distance between the inner diameter of the inner circumferential surface 17C of the enclosure 17. This implies that the resonance amplitude can be controlled if the outer circumference area of the optical disk 11 is enclosed firmly with the enclosure 17.

Thus, according to an embodiment of the present invention, a cylindrical space forming unit forming approximately air-tight cylindrical space includes the turntable insertion slot 18 for rotating the optical disk 11 and the optical pickup insertion opening portion 19 for inserting the optical pickup to record signals on and reproduce signals from the optical disk 11. The insertion slot for inserting the disk damper 9 may be formed at the opposite side of the turntable insertion slot 18, and may be formed in the upper surface of the enclosure 17. Or, the insertion slot for inserting the disk damper 9 may be enclosed air-tightly.

Subsequently, a preferable range for the distance between the edge of the outer circumference of the optical disk 11 and the inner circumferential surface 17C of the enclosure 17 and a preferable range for the distance between the surfaces of the optical disk 11 and the inner surfaces 17A and 17B of the enclosure 17 were examined.

First, the inner diameter D of the inner circumferential surface 17C of the enclosure 17 for enclosing the optical disk 11 was varied, and the differences in resonance amplitude with the various disk rotational speeds were measured. In the optical disk drive apparatus having the arrangement shown in FIG. 1, the differences in the resonance amplitude were measured under conditions where the distance L between the upper and lower surfaces 17A and 17B of the optical disk 11 and the respective inner surfaces 17A and 17B of the enclosure 17 was determined as 2 mm; and the inner diameter D of the inner circumferential surface 17C of the enclosure 17 was determined 122 mm, 125 mm, 130 mm and 140 mm, respectively. An outer diameter of the optical disk 11 was 120 mm. FIG. 13 shows measured results of the differences in the resonance amplitudes.

FIG. 13 shows that the resonance amplitude can be controlled under the condition where the inner diameter D of the inner circumferential surface 17C of the enclosure 17 is within a range of 122 mm to 140 mm. More specifically, if the distance between the edge of the outer circumference of the optical disk 11 and the inner circumferential surface 17C of the enclosure 17 forming the cylindrical space 20 is within a range of from 1 mm to 10 mm, the resonance amplitude can be securely controlled when rotating the optical disk at up to a rotational speed of 20000 rpm.

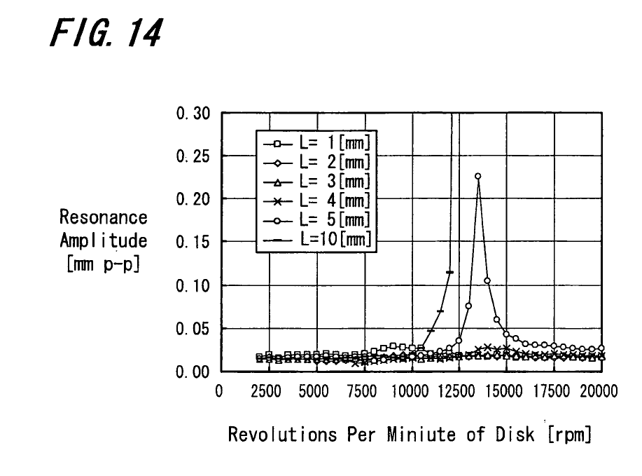

Next, a relationship between the surfaces of the optical disk and the inner surfaces of the enclosure was examined. In arrangements similar to those of the aforementioned optical disk drive apparatus shown in FIG. 1, the inner diameter of the inner circumferential surface 17C of the enclosure 17 was determined as 125 mm, the distance L between the inner surfaces 17A and 17B of the enclosure 17 and the upper and lower surfaces 11A and 11B of the optical disk was determined as 1 mm, 2 mm, 3 mm, 4 mm, 5 mm and 10 mm, respectively, and the differences in the resonance amplitude with respective rotational speeds were measured. FIG. 14 shows measured results.

FIG. 14 shows that when the distance between the surfaces of the optical disk 11 and the inner surfaces of the enclosure 17 is within a range of from 1 mm to 4 mm, the resonance amplitude can be sufficiently inhibited at a rotational speed of 2000 rpm to 20000 rpm. It should be noted that when the distance L was determined as 10 mm, the resonance amplitude exceeded the measuring limit of a measuring instrument, which was the rotational speed higher than 12500 rpm. Therefore, the differences in the resonance amplitude were not obtained.

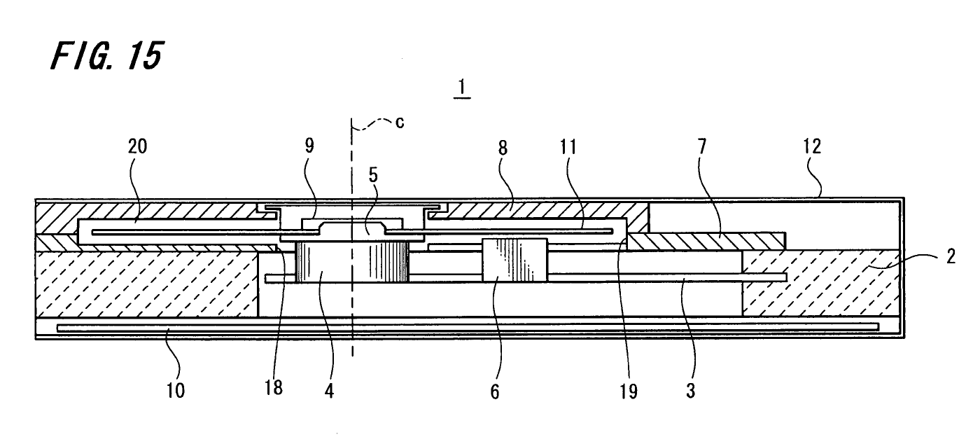

Next, an optical recording-reproducing apparatus including the optical disk drive apparatus according to an embodiment of the present invention will be described. The following embodiment shows an example of a space forming unit for covering the optical disk that forms the cylindrical space, such as the cover that is formed of two or more parts. FIG. 15 is a schematic cross-sectional view showing arrangements of the optical recording-reproducing apparatus including the optical disk drive apparatus according to the embodiment of the present invention. The optical disk drive apparatus includes a mechanical chassis 2, a base unit chassis 3 (hereinafter simply referred to as a “BU chassis 3”) rotatably attached to the mechanical chassis 2, a spindle motor 4 attached to the BU chassis 3, a turntable 5 attached to the upper portion of the spindle motor 4 and rotatable with the spindle motor 4, an optical pickup 6 movably attached to the BU chassis 3 in the radius direction of the optical disk 11, a lower cover 7 movably attached to the mechanical chassis 2 and used as a disk tray, an upper cover 8 attached to the mechanical chassis 2, a disk damper 9 rotatably supported on the upper cover 8, a control substrate 10 attached to the mechanical chassis 2, and a housing 12 for accommodating therein the elements and parts.

The disk damper 9 is magnetically adsorbed onto the turntable 5 with a magnet (not shown). The optical disk 11 is secured onto the lower cover 7 by magnetic force, thereby causing the optical disk 11 to rotate with the spindle motor 4.

The mechanical chassis 2A includes a driving mechanism (not shown) to slidably move the lower cover 7 and a driving mechanism to move the BU chassis 3 in the upper and lower directions.

FIG. 15 shows a state in which the optical disk 11 is clamped and loaded on the upper portion of the spindle motor 4 by the turntable 5 and the disk damper 9.

In this state, the lower cover 7 and the upper cover 8 are air-tightly attached with each other without gaps between the contact surfaces. Further, the cylindrical space 20 is formed by the lower cover 7 and the upper cover 8 around the circumferential surface of the optical disk 11 such that the inner surfaces of the cover face the surfaces of the optical disk 11 with a distance ranging from 1 to 4 mm and the edge of the outer circumferential surface of the optical disk 11 and the inner circumferential surface of the cover forming the cylindrical space 20 face with a distance ranging from 1 to 10 mm.

It should be noted that FIG. 15 shows the state in which the turntable insertion slot 18 and the optical pickup insertion opening portion 19 are communicated with each other and hence continuously opened; however, the present invention is not limited thereto, and the turntable insertion slot 18 and the optical pickup insertion opening portion 19 may be formed separately.

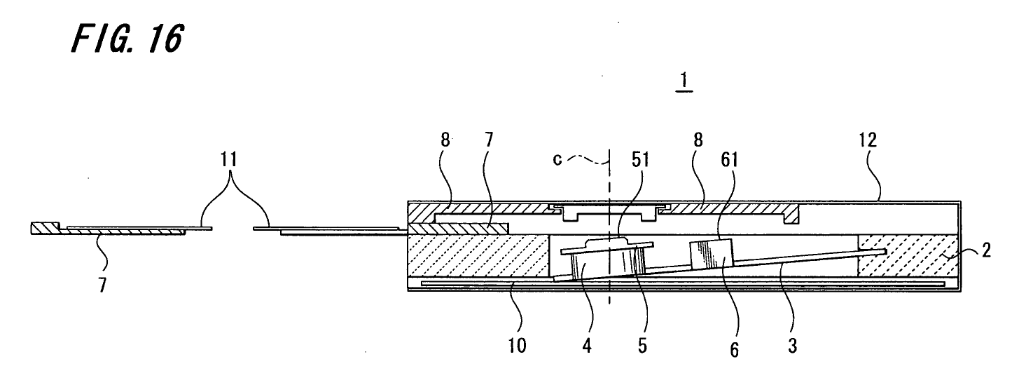

Here, the operation to load the optical disk 11 on the optical disk drive apparatus 1 will be described with reference to FIG. 16. In FIG. 16, elements and parts identical to those of FIG. 15 are denoted by identical reference numerals and corresponding descriptions are thus omitted.

FIG. 16 shows the state in which the lower cover 7 is slidably moved up to an optical disk replace position.

Disk eject operation is activated by pressing a disk eject switch attached to a front panel (not shown) of the optical recording-reproducing apparatus, for example, with a finger or by inputting disk eject signals to the optical disk drive apparatus 1 from any appropriate apparatus such as a host computer (not shown). First, the BU chassis 3 is moved. The right-hand portion of the BU chassis 3 is rotatably supported on the mechanical chassis 2. When the driving mechanism (not shown) operates to move the BU chassis 3 in the upper and lower directions, the left-hand portion of the BU chassis 3 is moved in the lower direction, and an upper portion 51 of the turntable 5 and an upper portion 61 of the optical pickup 6 are located at the position lower than the lower surface of the lower cover 7. Thus, the BU chassis 3 is allowed to slidably move to the lower cover 7 in the left-hand direction as shown in FIG. 16. Next, the lower cover 7 is slidably moved in the left-hand direction. When a driving mechanism (not shown) operates to move the lower cover 7, the lower cover 7 is slidably moved in the left-hand direction and continuously moved upto the optical disk replace position shown in FIG. 16. The optical disk is replaced at this position, and the optical disk loading operation is activated thereafter.

The optical disk loading operation is activated by pressing the lower cover 7, for example, with a finger or by inputting signals to the optical disk drive apparatus 1 from any appropriate apparatus such as a host computer (not shown). First, when the driving mechanism operates to move the lower cover 7, the lower cover 7 is slidably moved in the right-hand direction as shown in FIG. 16 and continuously moved to the optical disk loading position as shown in FIG. 15. Next, when a driving mechanism (not shown) operates to move the BU chassis 3 in the upper and lower directions, the left-hand portion of the BU chassis 3 is moved in the upper and lower directions. At this state, the optical disk drive apparatus 1 is configured as shown in FIG. 15. As a result, the cylindrical space 20 is formed around the optical disk 11 with a predetermined distance between the upper and lower surfaces and the edge of the outer circumference of the optical disk 11 and the respective inner surfaces of the cylindrical space forming unit, thereby forming the airtight cylindrical space 20.

As described above, according to this embodiment, the space forming unit forming the cylindrical space 20; that is, the lower cover 7 and the upper cover 8 form a structure such that the covers can be separated from each other when loading the optical disk 11 on or replacing the optical disk 11 from the optical disk drive apparatus 1.

It should be noted that the upper cover 8 is formed independently of the housing 12 in the embodiment shown in FIG. 15; however, the present invention is not limited thereto. Both the upper cover 8 and the housing 12 may be united to form one unit to reduce the number of parts forming a cover.

Next, another embodiment of the optical recording-reproducing apparatus according to an embodiment of the present invention will be described.

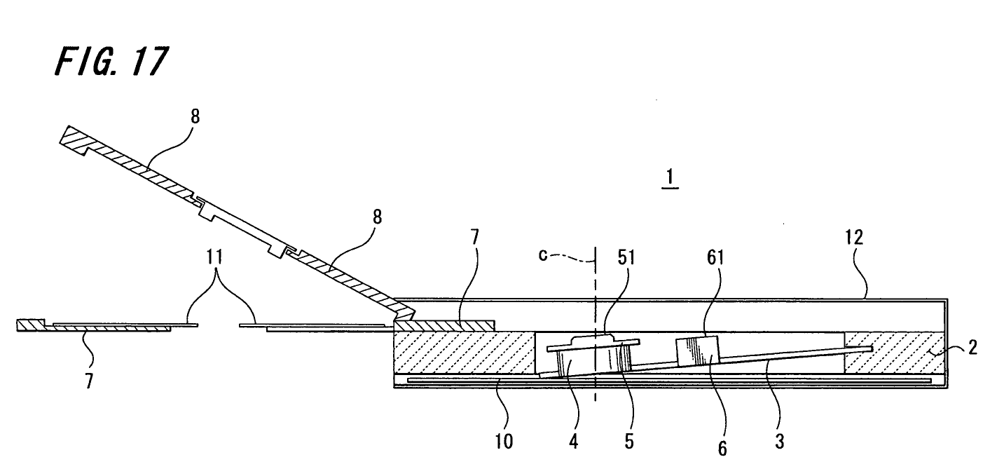

The upper cover 8 is fixed to the housing 12, and the lower cover 7 alone can be slidably moved when the optical disk 11 is ejected from and loaded onto the optical disk drive apparatus 1 according to the embodiment shown in FIG. 16. However, according to an embodiment shown in FIG. 17, the upper cover 8 is movably attached to the lower cover 7. That is, the upper cover 8 is rotatably attached to one end of the lower cover 7 in FIG. 17. When the upper cover 8 and the lower cover 7 are slidably moved to the optical disk loading position or the optical disk replace position, the upper cover 8 can be rotated around a fixed point as a central axis. In FIG. 17, elements and parts identical to those of FIG. 15 are denoted by identical reference numerals and corresponding descriptions are thus omitted.

According to the embodiment described above, while the lower cover 7 and the upper cover 8 are moved to the optical disk loading position or the optical disk replace position by a mechanism similar to that of the example shown in FIG. 16, the optical disk 11 can be loaded on the optical disk drive apparatus 1 or the optical disk 11 can be replaced by rotatably moving the upper cover 8 in the upper direction.

It should be noted that the space forming unit for enclosing the optical disk 11 that forms the cylindrical space 20 includes two or more parts such as the upper cover and the lower cover. In particular, the space forming unit includes the dividing portion in the inner circumferential surface of the space forming unit corresponding to the position of the outer circumference of the optical disk 11. The cover should be thick enough to prevent vibration and include a sufficient width of contact surfaces of the respective parts. That is, the cover should include a sufficient thickness to block off the airflow from flowing in the radius direction.

The width (thickness of the enclosure) of the contact surfaces of the respective parts may preferably be 1 mm or more in order to control resonance of the optical disk.

The optical disk drive apparatus and the optical recording-reproducing apparatus according to an embodiment of the present invention are suitable for optical disks to rotate at a high speed.

The following table 1 shows rotational speeds at the inner circumference and outer circumference of a BD (Blu-ray Disk®) (25 GB type), a DVD (Digital Versatile Disk) (dual-layer disk) and a CD (Compact Disk).

The table 2 shows variability of rotational speeds between the inner circumference and outer circumference of the BD, DVD and CD corresponding to the rotational speed of 20000 rpm.

The table 3 shows respective tolerances of outer diameters of the disks, eccentricities of outer diameters of the disks, and disk deflections in the BD, DVD and CD.

TABLE 1
ROTATINAL SPEED OF DISKS
ROTATINAL SPEED (EQUIVALENT TO 1x SPEED)

| | BD CAPACITY | DVD | |
|---|---|---|---|
| | 25 GB | DUAL-LAYER DISK | CD |
| REVOLUTIONS PER | 1955 | 1528 | 497 |
| MINUTE (INNER | | | |
| CIRCUMFERENCE) | | | |
| [rpm] | | | |
| REVOLUTIONS PER | 802 | 627 | 214 |
| MINUTE (OUTER | | | |
| CIRCUMFERENCE) | | | |
| [rpm] | | | |

TABLE 2
SPEED MAGNIFICATIONS AT 20000 [rpm]
SPEED MAGNIFICATIONS (APPROX.) AT 20000 [rpm]

| | BD | DVD | |
|---|---|---|---|
| | CAPACITY | DUAL-LAYER | |
| | 25 GB | DISK | CD |
| REVOLUTIONS PER | 10x SPEED | 13x SPEED | 40x SPEED |
| MINUTE (INNER | | | |
| CIRCUMFERENCE) | | | |
| REVOLUTIONS PER | 25x SPEED | 32x SPEED | 93x SPEED |
| MINUTE (OUTER | | | |
| CIRCUMFERENCE) | | | |

TABLE 3
DISK DIMENSIONS

| | BD | DVD | |
|---|---|---|---|
| | CAPACITY | DUAL-LAYER | |
| | 25 GB | DISK | CD |
| DISK OUTER | φ120 ± 0.3 | φ120 ± 0.3 | φ120 ± 0.3 |
| DIAMETER [mm] | | | |
| ECCENTRICITY OF | ±0.15 | ±0.15 | ±0.2 |
| DISK OUTER | | | |
| DIAMETER [mm] | | | |
| DISK DEFLECTION | ±0.3 | ±0.3 | ±0.4 |
| [mm] | | | |

As can be seen from the tables 1 to 3, in the optical disk drive apparatus and the optical recording-reproducing apparatus according to an embodiment of the present invention, if the rotational speed is applied to the BD as 10× speed, to the DVD as 13x speed, and to the CD as 40× speed, resonance amplitude can be controlled with high reliability and stable recording and reproducing operations can be realized.

As set forth above, in the optical disk drive apparatus and the optical recording-reproducing apparatus according to an embodiment of the present invention, since the optical disk drive apparatus and the optical recording-reproducing apparatus include the arrangements in which the optical disk located at the airtight space is supported and rotated, the effects on preventing an increase of resonance amplitudes can be obtained up to the rotational speed of 10000 rpm to 20000 rpm. In addition, the stable recording and/or reproduction can be realized.

It should be noted that the optical disk drive apparatus and the optical recording-reproducing apparatus according to an embodiment of the present invention are not limited to those of the above-mentioned embodiments. The optical disk drive apparatus and the optical recording-reproducing apparatus can be variously modified and changed without departing from the arrangements of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disk drive apparatus, comprising:
a cylindrical space forming unit that forms a cylindrical space, wherein
an optical disk is located such that an upper surface, a lower surface and an edge of an outer circumference of an optical disk face inner surfaces of the cylindrical space forming unit with a predetermined distance.

2. An optical disk drive apparatus according to claim 1, wherein
a distance between the edge of the outer circumference of the optical disk and the inner circumferential surface of the cylindrical space forming unit is within a range of 1 mm to 10 mm.

3. An optical disk drive apparatus according to claim 1, wherein
a distance between the upper and lower surfaces of the optical disk and the inner surfaces of the cylindrical space forming unit facing the upper and lower surfaces of the optical disk is within a range of 1 mm to 4 mm.

4. An optical disk drive apparatus according to claim 1, wherein
the cylindrical space forming unit includes a rotary shaft fixed portion insertion slot for the optical disk and an optical pickup insertion slot formed at portions of the inner surfaces of the cylindrical space forming unit facing the upper and lower surfaces of the optical disk.

5. An optical disk drive apparatus according to claim 1, wherein
a space forming unit forming the cylindrical space includes two or more parts.

6. An optical disk drive apparatus according to claim 5, wherein
a lower part of the space forming unit forming the cylindrical space is a disk tray on which the optical disk is loaded.

7. An optical disk drive apparatus according to claim 5, wherein
the parts of the space forming unit forming the cylindrical space can be separated when the optical disk is loaded or when the optical disk is replaced.

8. An optical disk drive apparatus according to claim 5, wherein
an upper part of the space forming unit forming the cylindrical space is movably attached to the lower part of the space forming unit.

9. An optical recording-reproducing apparatus for recording and/or reproducing data by irradiating the optical disk with light, comprising:
the optical disk drive apparatus including the cylindrical space forming unit that forms the cylindrical space, wherein
the optical disk is located such that the upper surface, the lower surface and the edge of an outer circumference of the optical disk face inner surfaces of the cylindrical space forming unit with a predetermined distance.
